(19) United States
(12) Patent Application Publication
(10) Pub. No.: US 2007/0169398 A1
(43) Pub. Date: Jul. 26, 2007

(54) Artificial fishing bait

(76) Inventor: Robert Taszarek, Poznan (PL)

Correspondence Address: ROBERT TASZAREK, W. CZECHOSTOWACKA 6B/1, POZNAN, 61-461, PL

(21) Appl. No.: 10/931,063

(22) Filed: Sep. 1, 2004

(30) Foreign Application Priority Data
Jul. 30, 2004 (PL) P 369342

(51) Int. Cl. A01K 85/00; A01K 85/10

(52) U.S. Cl. 43/42.19; 43/42.13

(57) ABSTRACT

What is characteristic of the artificial fishing lure body is that on the common axis (1) of the lure body with the body of the spoon (2) and with a rotational clevis (3) with an attached wing (4) of the spoon there are rotationally placed one, two or more devises (5). Attached to these devises (5) are an anchor (6) or a hook (7) or a weight (8) or a shackle (9) or a split ring (10) or a line (11) or a swivel (12) directly or indirectly to the axis (1) of the bait. The devises (5) are separated by the distance sleeves (14) and those situated on the flexible connection are bilaterally limited by the stops (15). The clevis (5) can be also situated in the wobbler (16).

The subject of the invention is an artificial fishing bait meant to lure fish in order to catch them with a fishing rod. World-wide known is an artificial fishing lure bait in which the clevis in the shape of a horseshoe with wholes in its ends is fixed on an axis in the form of a wire together with the body of a rotational spoon and with an anchor-hook. The wing of the spoon or the pallet of the rotational spoon are fixed separately to the clevis. While the whole artificial lure bait is lead in the water, the wing of the spoon or its pallet spin attached rotationally on the clevis around the body of the spoon.

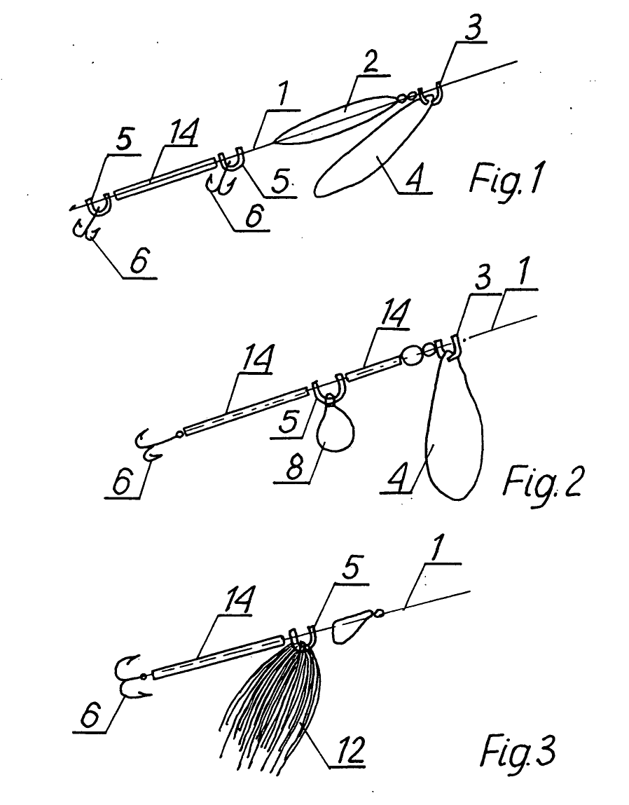

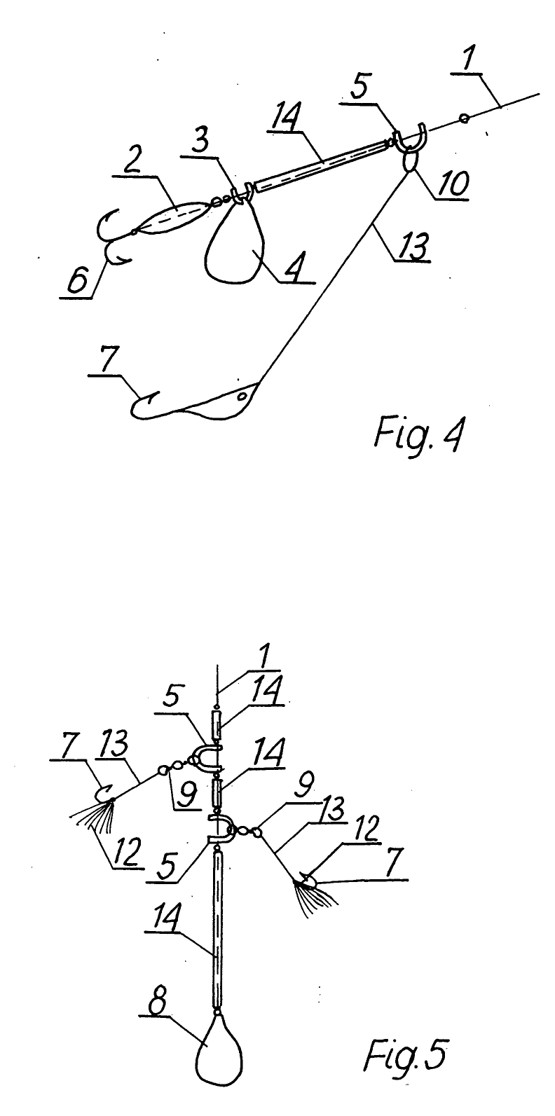

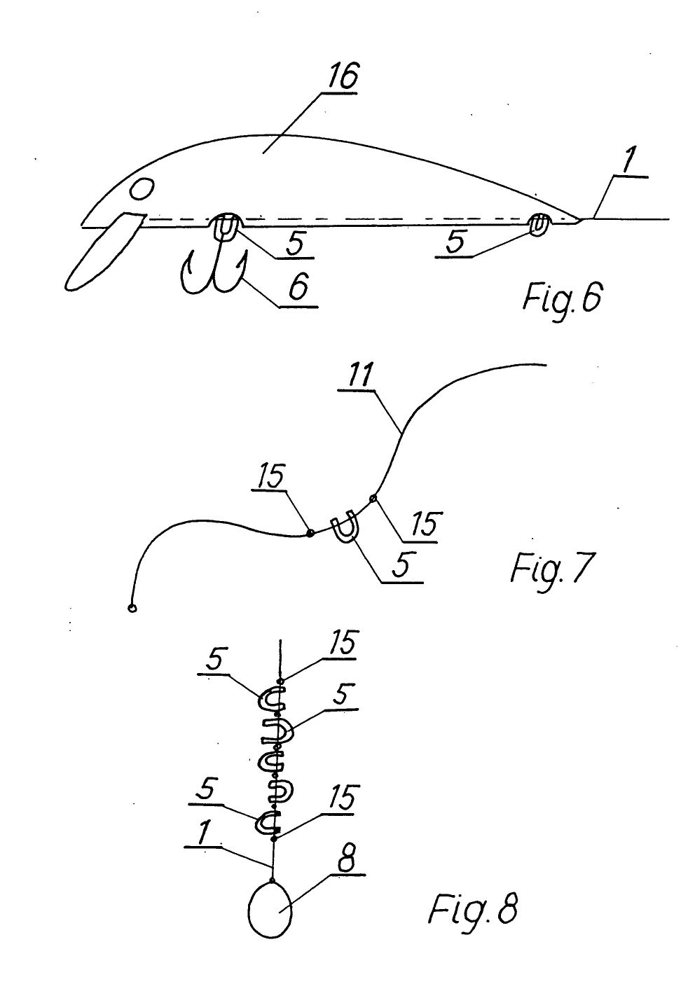

According to the invention the artificial fishing bait has additionally one, two or more devises placed rotationally on the common axis of the lure body with the body of the spoon and with the rotational spoon with the attached wing of the spoon. To the additional devises there are joined an anchor or a hook or a swivel or the split ring or a fishing line or a swivel. These elements are joined directly to the axis of the lure body or indirectly to this axis by means of an additional connection in the form of a wire, string or a fishing line. Two or more situated devises are separated adequately by distance sleeves and the devises situated on the flexible connection and especially on the fishing line are bilaterally limited by stops. The clevis can be also situated commonly on the axis of the lure body in the wobbler. Using the clevis in the invention in the construction of the artificial fishing bait for other purposes than hanging on it the wing of the spoon or the pallet of the rotational spoon unexpectedly allowed the development in the construction of other artificial fishing baits. The subject of the invention in the examples of the workmanship has been presented in the picture, in which FIG. 1 shows an artificial fishing bait where the devises were used for fixing anchors on them, FIG. 2 shows a bait where the clevis was used for fixing a weight, FIG. 3 shows a bait where the clevis was used for fixing a swivel made of a bunch of feathers or horsehair, FIG. 4 shows a bait with hanging through clevis an additional element luring with a hook by means of an additional connection, FIG. 5 shows a bait where shackles were used to which at the end of additional connections there are attached swivels with hooks, FIG. 6 shows a bait where a clevis in a wobbler was used, FIG. 7 shows a bait where a clevis situated on a cord or line between the stops was used, FIG. 8 shows a bait where the devises hung together with the hooks on the flexible connection like in a Christmas tree are used. According to the invention the artificial bait has rotationally placed on the common axis 1 of the lure body with the body of the spoon 2 and with the rotational clevis 3 with the attached wing 4 of the spoon one, two or more additional devises 5, to which attached are an anchor 6 or a hook 7 or a weight 8 or a shackle 9 or a split ring 10 or a line 11 or a swivel 12. These elements are attached directly to the axis 1 of the lure body or indirectly to this axis I by means of an additional connection 13 in form of a wire, cord-plaited fabric or a fishing line. Two or more devises situated next to each other are separated adequately by distance sleeves 14. The devises 5 are situated on the flexible connection, especially on the line 11 or on the cord-plaited fabric, bilaterally limited by the stops 15. The clevis 5 can be also situated commonly on the axis 1 in the wobbler 16. The devises 5 together with the hooks 7 can be hung together on the flexible connection in form of a line or a cord-plaited fabric like in a Christmas tree. The stops 15 can be made of metal, rubber or plastic elements.

1. The artificial bait is provided with a clevis in the shape of a horseshoe attached rotationally on a wire with a wing of the spoon or a pallet, which additionally has the body of the spoon together with an anchor-hook. What is characteristic of the bait is that on its common axis (1) with the body of the spoon (2) and with a rotational clevis (3) with an attached wing (4) of the spoon there are rotationally placed one, two or more additional devises (5), to which attached are an anchor (6) or a hook (7) or a weight (8) or a shackle (9) or a split ring (10) or a line (11) or a swivel (12), while these elements are attached directly to the axis (1) of the lure body or indirectly to this axis by means of an additional connection (13) in form of a wire, cord or a fishing line.

2. According to reservation 1 the artificial fishing bait, of which the characteristic feature is that two or more clevises (5) placed next to each other are adequately separated by the distance sleeves (14).

3. According to reservation 1 the artificial fishing bait, of which the characteristic feature is that the devises (5) situated on the flexible connection, especially on the line (11), are bilaterally limited by the stops (15).

4. According to reservation 1 the artificial fishing bait, of which the characteristic feature is that the clevis (5) is situated commonly on the axis (1) of the fishing bait in the wobbler (16).
